(19) United States
(12) Patent Application Publication
(10) Pub. No.: US 2017/0331348 A1
(43) Pub. Date: Nov. 16, 2017

(54) INTEGRATED ELECTRIC-PLANETARY DRIVETRAIN

(71) Applicant: James Rhett Mayor, Braselton, GA (US)

(72) Inventor: James Rhett Mayor, Braselton, GA (US)

(21) Appl. No.: 15/480,628

(22) Filed: Apr. 6, 2017

Related U.S. Application Data
(60) Provisional application No. 62/318,828, filed on Apr. 6, 2016.

(51) Int. Cl. H02K 7/00; H02K 7/116; H02K 1/27; H02K 11/33; F16H 1/28; B60L 11/18; B60K 1/00; H02K 11/00; F16H 57/02

(52) U.S. Cl. CPC H02K 7/006; B60K 1/00; H02K 7/116; H02K 1/278; H02K 11/0094; H02K 11/33; F16H 1/28; B60L 11/18; F16H 2057/02034; F16H 57/02

(57) ABSTRACT

According to various aspects According to various aspects, exemplary embodiments of a planetary drivetrain including an electric motor having a stator and rotor, with at least one planet gear attached to the rotor, the rotor mechanically coupled to at least two shafts, the integrated electric-planetary drivetrain electromechanically providing both torque and differential capabilities. In other embodiments, a vehicle comprised of one or more integrated electric-planetary drivetrains driving one or more sets of wheels. The vehicle can include one or more long term energy storage systems and one or more inverters and one or more controllers. The vehicle can also include one or more short term energy storage systems

### RELATED APPLICATION DATA

This application claims priority from U.S. Provisional Patent Application No. 62/318,828, which was filed on Apr. 6, 2016, which application is hereby incorporated herein by reference in its entirety.

### BACKGROUND

A drivetrain typically is a set of components that delivers power to driving wheels in such a manner as to provide the motive torque and differential action. Usually, a drivetrain includes a driveshaft that delivers power from the motor to a differential. The power delivered to the differential is transmitted to the wheels. The differential is connected to two half-shafts (each of which has a wheel connected thereto) and allows the wheels to turn at different rates. So for example, when a vehicle takes a turn, the differential allows the outer driving wheel to rotate faster than the inner driving wheel.

Existing drivetrains can offer disadvantages. In a typical drivetrain, where the motor is an internal combustion engine, the driveshaft adds weight to a vehicle, is subject to stress, and ultimately can fail over time. The driveshaft is also exposed, especially in commercial vehicles, which raises the risk of it being damaged.

Electric drivetrains, where the motor is an electric motor, can also offer disadvantages. In a typical all-electric application, multiple electric motors are used on each driving wheel, with each motor being separately controlled to effectuate the function of a differential. This configuration requires multiple motors, multiple inverters, and a controller, resulting in high powertrain costs that can be cost prohibitive. In a typical electric-mechanical drivetrain the electric motor is coupled to a transmission, with one or more gear ratios, which is then coupled to a mechanical differential. The system is then mechanically similar to existing drivetrains, simply substituting the electric motor over the conventional internal combustion engine, and thereby has similar disadvantages.

### SUMMARY

According to various aspects, exemplary embodiments of a planetary drivetrain including an electric motor having a stator and rotor, with at least one planet gear attached to the rotor, the rotor mechanically coupled to at least two shafts, the integrated electric-planetary drivetrain electromechanically providing both torque and differential capabilities.

In another embodiment, a vehicle comprised of one or more integrated electric-planetary drivetrains driving one or more sets of wheels. The vehicle can include one or more long term energy storage systems and one or more inverters and one or more controllers. The vehicle can also include one or more short term energy storage systems.

### DESCRIPTION OF THE DRAWINGS

FIG. 1 is a perspective view of an integrated electric-planetary drivetrain.

FIG. 2 is another perspective view of an integrated electric-planetary drivetrain.

FIG. 3 is another perspective view of an integrated electric-planetary drivetrain.

FIG. 4 is another perspective view of an integrated electric-planetary drivetrain.

### DETAILED DESCRIPTION

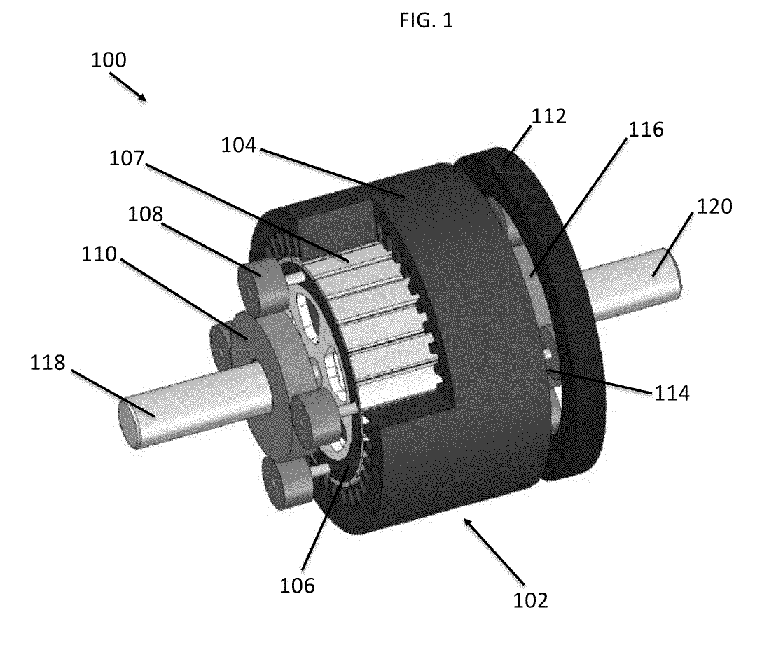

FIG. 1 is a perspective view of an integrated electric-planetary drivetrain 100. The integrated electric-planetary drivetrain 100 includes an electric motor 102 having a stator 104 and a rotor 106. In this embodiment, the rotor is lined with a plurality of permanent magnets 107. On one side of the electric motor 102, there are a plurality of planet gears 108 that are connected to the rotor 106. The planet gears 108 are mechanically coupled between a sun gear 110 and a ring gear. For illustrative purposes, the ring gear is not shown on the left side of the integrated electric-planetary drivetrain 100, but can be viewed as element 112 on the right side of the integrated electric-planetary drivetrain 100. The right side of the drivetrain includes symmetrical features as the left side. Specifically, the right side of the integrated electric-planetary drivetrain includes a plurality of planet gears 114 coupled between a ring gear 112 and sun gear 116. As with the planet gears 108, the planet gears 114 are connected to the rotor 106 of the electric motor 102.

The sun gears 110 and 116 are attached to output shafts 118 and 120 respectively. The output shafts 118 and 120 are mechanically coupled to the electric motor 102 through a central axis of the motor 102 as will be shown in subsequent figures. The planet gears 108 and 114 are connected to the rotor 106 through a central axis of the planet gear. This allows the planet gears to rotate around this central axis.

During operation of the integrated electric-planetary drivetrain 100, the electric motor 102 receives power from a power source such as a battery bank (not shown), which causes the rotor 106 to rotate. This rotation causes the planet gears 108 and 114 to rotate and revolve around the sun gears 110 and 116. The rotating and revolving action of the planet gears 108 and 114 causes the sun gears 110 and 116 to rotate, and since the sun gears 110 and 116 are attached to their respective output shafts 118 and 120, the rotation of the sun gears 110 and 116 rotates these shafts. In this way, the integrated electric-planetary drivetrain delivers torque to the shafts via the motor 102.

The integrated electric-planetary drivetrain 100 not only delivers torque to the shafts, it also acts as a differential. The connection of the planet gears 108 and 114 to the rotor 106 allows for this capability. So for example, the integrated electric-planetary drivetrain 100 can allow for the output shaft 118 to not rotate while the output shaft 120 rotates. This can arise, for example, in a vehicle making a sharp turn. In the situation where output shaft 118 and the sun gear 110 that it is connected to do not rotate, the rotor 106 will continue to rotate given that it is still receiving an input power. This means that the planet gears 108 will also continue to rotate and revolve around the sun gear 110. With the sun gear 110 stopped, the planet gears 108 will freely revolve around the sun gear 110. On the other side of the motor 102, the output shaft 120 continues to rotate because the rotor 106 continues to rotate. Specifically, the rotation of the rotor 106 causes the planet gears 114 to rotate and revolve around the sun gear 116. The sun gear 116 will then rotate causing the output shaft 120 to rotate.

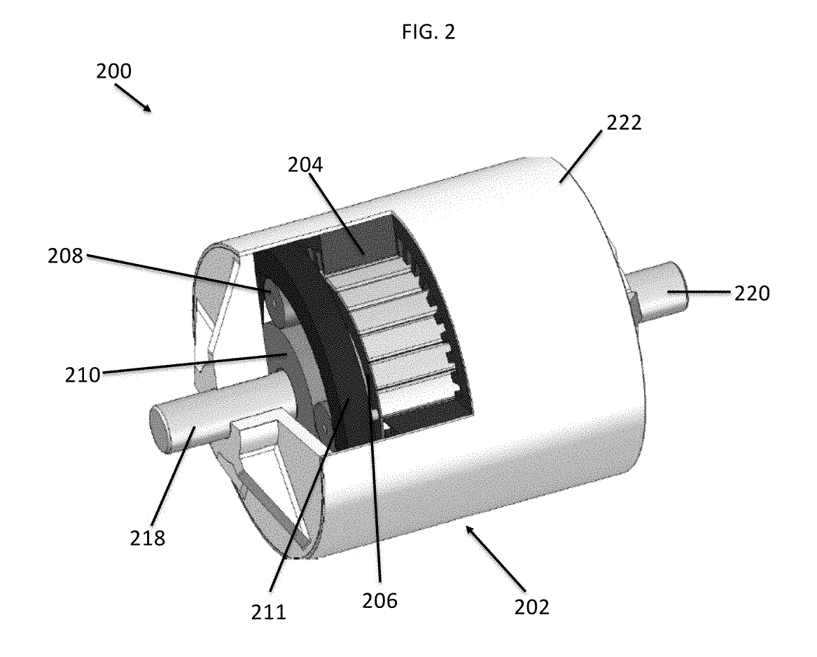

FIG. 2 is a perspective view of an integrated electric-planetary drivetrain 200. The integrated electric-planetary drivetrain 200 includes a casing 222, a part of which is cut out to illustrate features of the integrated electric-planetary drivetrain 200. As shown in FIG. 2, the integrated electric-planetary drivetrain 200 includes a motor 202 having a stator 204 and a rotor 206. Connected to the rotor 206 are planet gears 208, with the planet gears 208 mechanically coupled between a sun gear 210 and a ring gear 211. The sun gear 210 is attached to an output shaft 218. On the other side of the motor 202, FIG. 2 shows another output shaft 220. This other side of the motor 202 also includes a ring gear, planet gears, and a sun gear attached to the output shaft 220. They are not shown in FIG. 2 because they are located inside the casing 222.

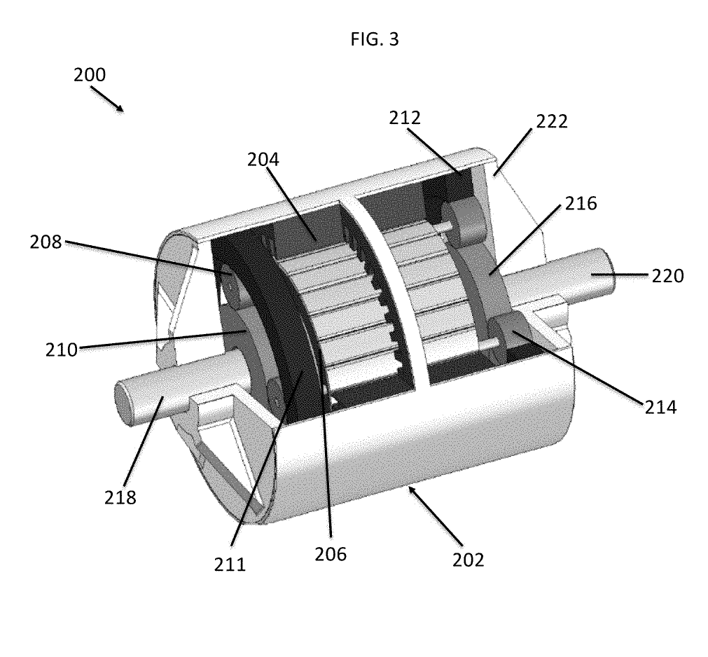

FIG. 3 is another perspective view of integrated electric-planetary drivetrain 200, which has portions cut out so that components of the integrated electric-planetary drivetrain 200 can be viewed. FIG. 3 shows the gears associated with the output shaft 220. This includes ring gear 212, a portion of which is cut away to view the planet gears 214 and the sun gear 216.

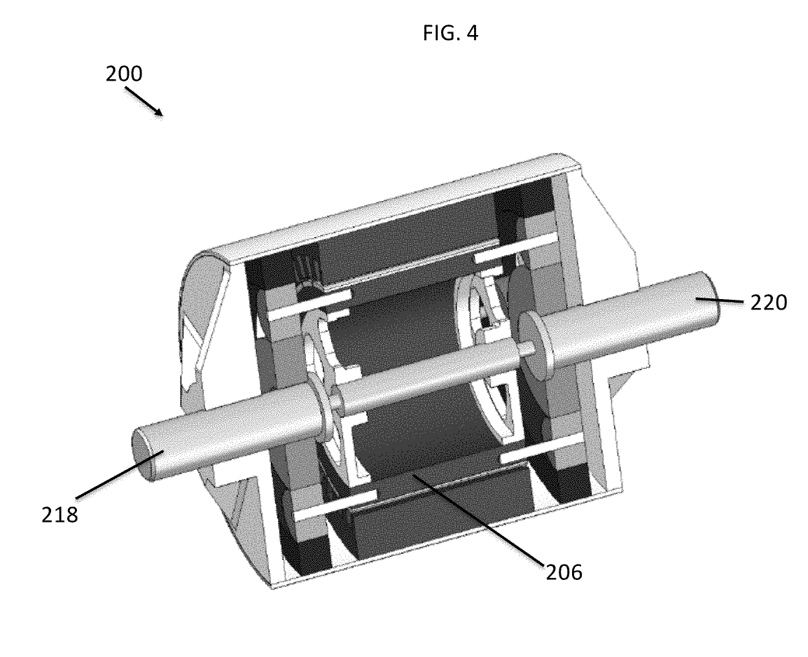

FIG. 4 is another perspective view of integrated electric-planetary drivetrain 200, which has portions cut out so that components of the integrated electric-planetary drivetrain 200 can be viewed. FIG. 4 shows the mechanical coupling of the output shafts 218 and 220 to the motor 202. Each shaft is mechanically coupled to a central axis of the rotor 206, with each shaft capable of independent rotation as described above.

The integrated electric-planetary drivetrain embodiments described herein provide torque to the output shafts and differential capabilities. In other words, unlike traditional differentials, the integrated electric-planetary drivetrains described herein do not require an external mechanical input power such as a driveshaft. The torque is provided by the integrated electric-planetary drivetrain electromechanically. And unlike prior drivetrain applications where electric motors are used, the integrated electric-planetary drivetrain described herein do not require multiple motors and inverters, and a mechanical differential. As a result, the integrated electric-planetary drivetrain described herein improves packaging of the drivetrain on the vehicle chassis and reduces cost. It also improves quality and performance in that a driveshaft for communicating mechanical input power is not required.

The integrated electric-planetary drivetrains described herein can be used in various applications including vehicular powertrains comprised of one or more integrated electric-planetary drivetrains that are used to drive one or more sets of wheels. The integrated electric-planetary drivetrains can also include long term energy storage, including without limitation battery banks (electro-chemical), fuel cells (electro-chemical), flywheel generators (electro mechanical), compressed air turbogenerators, and steam generators. The long term energy storage is used to deliver electric power to the motor of the integrated electric-planetary drivetrain. It will be appreciated that the integrated electric-planetary drivetrain alone or including energy storage can be applied to a wide variety of vehicles that require torque to be delivered to wheels, including without limitation automobiles, trucks, all-terrain vehicles, forklifts, golf carts, and any commercial and construction vehicles.

The integrated electric-planetary drivetrain can also include short term energy storage. In a vehicle such as a car, when a driver wants to stop the car, he or she will apply the brake which will typically clamp rotors. Energy is wasted during this operation in the form of heat generated by the clamping of the rotors. The integrated electric-planetary drivetrain having the short term energy storage allows this energy to be stored. Instead of braking the car using rotors, the integrated electric-planetary drivetrain can disengage from the long term energy storage. At this point the wheels of the car will still be rotating, which will turn the motor of the integrated electric-planetary drivetrain. So instead of delivering torque to the wheels, the motor will act as a generator. The short term energy storage will store this generated energy. The short term energy storage can be one or more capacitors, including without limitation ultracapacitors or supercapacitors, for electric potential energy storage. Alternatively the short term storage could be other energy storage systems for example, without limitation, hydraulic or fluid-power systems or pneumatic systems wherein the recovered energy from braking is used to increase the pressure of the working fluid in the system.

While embodiments have been illustrated and described herein, it is appreciated that various substitutions and changes in the described embodiments may be made by those skilled in the art without departing from the spirit of this disclosure. The embodiments described herein are for illustration and not intended to limit the scope of this disclosure.

1. A planetary drivetrain comprising:
an electric motor having a stator and rotor;
at least one planet gear attached to the rotor;
at least two shafts mechanically coupled to the rotor, wherein the drivetrain electromechanically provides both torque and differential action to the shafts.

2. The drivetrain of claim 1 further comprising a plurality of planet gears, wherein one planet gear is attached at a first end of the rotor and another planet gear is attached at a second end of the rotor.

3. The drivetrain of claim 2 further comprising first and second sun gears, wherein the first sun gear attached to one of the at least two shafts, the second sun gear attached to another one of the at least two shafts, and the sun gears are mechanically coupled to the plurality of planet gears.

4. The drivetrain of claim 3 further comprising a plurality of ring gears, wherein the plurality of planet gears is mechanically coupled between one of the first and second sun gears and one of the plurality of ring gears.

5. The drivetrain of claim 4 wherein the rotor is configured to rotate when one of the two shafts is not rotating and the other of the two shafts is rotating.

6. The drivetrain of claim 1 wherein the rotor includes permanent magnets.

7. The drivetrain of claim 1 wherein the drive train is coupled to a short term electric storage, the short term electric storage storing energy generated from the drivetrain.

8. The drivetrain of claim 7 wherein the short term electric storage is a capacitor.

9. The drivetrain of claim 1 wherein the electric motor receives power from a long term storage.

10. The drivetrain of claim 9 wherein the long term storage is a battery bank.

11. The drivetrain of claim 1 further comprising one or more inverters.

12. The drivetrain of claim 11 further comprising one or more controllers.

13. A vehicle comprising of one or more drivetrains of claim 1 driving one or more sets of wheels.

14. The vehicle of claim 13 including one or more long term energy storage systems and one or more inverters and one or more controllers.

15. The vehicle of claim 14 including one or more short term energy storage systems.

16. A vehicle including a planetary drivetrain comprising:
an electric motor having a stator and a rotor,
a plurality of planet gears attached to the rotor, wherein one planet gear is attached at a first end of the rotor and another planet gear is attached at a second end of the rotor,
at least two shafts mechanically coupled to the rotor;
first and second sun gears, wherein the first sun gear is attached to one of the at least two shafts, the second sun gear is attached to another one of the at least two shafts, and the sun gears are mechanically coupled to the plurality of planet gears;
a plurality of ring gears, wherein the plurality of planet gears is mechanically coupled between one of the first and second sun gears and one of the plurality of ring gears.

17. The vehicle of claim 16 including a long term energy storage.

18. The vehicle of claim 17 wherein the long term energy storage comprises a battery bank.

19. The vehicle of claim 16 including a short term energy storage.

20. The vehicle of claim 16 wherein the short term energy storage comprises a capacitor.
